(19) United States
(12) Patent Application Publication
(10) Pub. No.: US 2026/0361552 A1
(43) Pub. Date: Nov. 12, 2026

(54) A COMPUTER-IMPLEMENTED METHOD OF ISSUING CERTIFICATES

(71) Applicant: UNIVERSITY OF PRETORIA, Pretoria (ZA)

(72) Inventor: Sean KRUGER, Pretoria (ZA)

(21) Appl. No.: 19/487,039

(22) PCT Filed: Jun. 1, 2023
(86) PCT No.: PCT/IB2023/055635

§ 371 Date: Nov. 24, 2025

(51) Int. Cl. H04L 9/32; G06F 21/64; H04L 9/00

(52) U.S. Cl. CPC H04L 9/3268; G06F 21/64; H04L 9/3213; H04L 9/3236; H04L 9/50

(57) ABSTRACT

This invention relates to a method 20, 30 of issuing and verifying certificates. The method includes receiving 21, at an NFT assigner 14, a request from an issuer 12 to issue an NFT associated with a certificate. The NFT assigner then validates 22, using a validation module 14.2, the request using cryptographic techniques, ensuring that the request is authentic and authorized. Once the request is validated, the NFT assigner 14 generates 23, using an NFT generator 14.1, a unique and non-interchangeable NFT associated with the certificate. The NFT is then stored or recorded 24 on the blockchain network 16, providing an immutable and transparent record of ownership and authenticity. The NFT assigner 14 then issues 26 the generated NFT to the issuer 12 through the API, providing a standardized and secure way to retrieve the NFT and verify authenticity of the certificate thus preventing fraudulent falsification of degree certificates.

### FIELD OF INVENTION

This invention relates to non-fungible tokens (NFTs) and to the issuance of verifiable certificates for use in the education sector.

### BACKGROUND OF INVENTION

Blockchain is a distributed ledger technology that allows secure and transparent peer-to-peer transactions without the need for intermediaries. A blockchain network consists of a network of nodes, each of which maintains a copy of the blockchain. Each block in the blockchain contains a cryptographic hash of the previous block, creating an immutable chain of transactions. One of the key features of blockchain technology is the ability to create smart contracts. Smart contracts are self-executing contracts that are stored on the blockchain and automatically execute when certain conditions are met. They can be used for a variety of purposes, from financial transactions to supply chain management. Smart contracts are written in a programming language that is specific to the blockchain network being used.

To store and retrieve data off the blockchain, an InterPlanetary File System (IPFS) is used which is a peer-to-peer protocol. Unlike traditional file storage systems, IPFS stores files using content-based addressing, which means that each file is identified by its unique content hash rather than its location on the network. IPFS can be used in conjunction with blockchain technology to store large files on the blockchain. This allows users to access and verify the content without the need for a centralized file storage system.

Non-Fungible Tokens (NFTs) are a type of digital asset that leverage blockchain technology to provide an immutable and verifiable record of ownership, uniqueness, and authenticity. NFTs are built on top of blockchain networks and are used to represent a wide range of digital and physical assets, such as artworks, and collectibles. NFTs play a crucial role in authenticating transactions within the blockchain ledger by providing a unique and non-interchangeable token that verifies ownership of a specific asset. The tokenization of assets through NFTs ensures that they cannot be replicated or manipulated, providing greater trust and transparency in the transfer of ownership and value. Unlike fungible tokens like cryptocurrencies, each NFT is unique and can represent a one-of-a-kind digital item such as artwork, music, or collectibles. Each NFT is created as a unique token on a blockchain network, and the ownership of the token is recorded in the blockchain ledger. This makes it possible to verify the ownership and authenticity of an NFT without the need for intermediaries. NFTs are typically created using smart contracts, which are self-executing contracts that automatically enforce the terms of the agreement. The smart contract defines the ownership and transfer rules of the NFT, as well as any royalties or fees that the creator may be entitled to. One of the key technical aspects of NFTs is their use of metadata. Metadata is additional information that is stored alongside the NFT, such as the name of the creator, the date of creation, and a description of the item. This metadata is important for verifying the authenticity and ownership of the NFT, as well as for displaying information about the item.

Blockchain applications are still nascent. However, blockchain technology is gaining significant uptake and application in various industries such as finance, healthcare, and supply chain management, where secure and transparent record-keeping is critical. Essentially, a blockchain is a decentralized and distributed digital ledger of growing records called blocks. Each block contains transaction data, a timestamp, and a cryptographic hash of the previous block, forming a chain of blocks that cannot be altered retroactively without altering subsequent blocks. The cryptographic hash function and timestamp provide tamper-proof security, making blockchain resistant to modification of data.

US20210097508A1 discloses a method for creating many NFTs on the Ethereum blockchain to ensure secure ownership and management of digital assets. The method involves determining the number of tokens to create in a batch and minting them using a token identifier for the first and last token in the batch. A single event is emitted for the creation of the batch of non-fungible tokens, which is then stored in an external ownership database. This approach enables accurate tracking of ownership and enhances the security of digital assets on the Ethereum blockchain.

The invention aims to address problems associated with falsification of qualifications, more specifically, fraudulent creation of false hard and/or soft versions of certificates issued by educational institutions.

### SUMMARY OF INVENTION

In accordance with a first aspect of the invention, there is provided a computer-implemented method of issuing a certificate, the method including:
receiving, via an application programming interface (API), a request to issue a certificate from an issuer;
generating, using an NFT generator, a non-fungible token (NFT) associated with the certificate;
recording, using a processor, the NFT on blockchain; and
issuing, via the application programming interface (API), the NFT to the issuer.

The method may include validating, using a validation module, the request using cryptographic techniques prior to generating the NFT. The method may further include verifying certificate authenticity and ownership of the NFT without the need for intermediaries by:
receiving, via the application programming interface, a certificate verification request from a requestor;
querying, using the processor, the blockchain in respect of the NFT in question; and
creating, using the processor, a verification response; and
forwarding, via the application programming interface, the verification response to the requestor.

The issuer may be a Massive Open Online Content (MOOC) provider. Furthermore, the issuer may be an educational institute, for example, a university.

In accordance with another aspect of the invention, there is provided a certificate issuing system which includes:
an NFT assigner which includes an NFT generator;
a processor; and
memory having program instructions stored thereon, which when executed by the certificate issuing system enable the system to:
receive, via an application programming interface (API), a request to issue a certificate from an issuer;
generate, using the NFT generator, a non-fungible token (NFT) associated with the certificate;
record, using the processor, the NFT on blockchain; and
issue, via the application programming interface (API), the NFT to the issuer.

The certificate issuing system may be configured to:
validate, using a validation module, the request using cryptographic techniques prior to generating the NFT.

The certificate issuing system may further be configured to verify certificate authenticity and ownership of the NFT without the need for intermediaries by:
receiving, via the application programming interface, a certificate verification request from a requestor;
querying, using the processor, the blockchain in respect of the NFT in question; and
creating, using the processor, a verification response; and
forwarding, via the application programming interface, the verification response to the requestor.

The invention also extends to a non-transitory computer-readable storage medium having program instructions stored thereon, which, when executed by a computing system, enable the computing system to perform the method steps described above.

For this invention, the Ethereum blockchain may be used. The Javascript programming language may be used to compile smart contracts into bytecode, which is then deployed to the blockchain network.

The method and system may make use of an electronic distributed ledger referred to as a blockchain to assign a customised Non-Fungible Token (NFT) that is verified using an Application Programming Interface (API) to a certificate. The activation and assigning of the NFT may be performed through smart contracts. Smart contracts may activate the NFT, while the NFT can only be owned by one person at a time to represent ownership of a real world object. Any form of certification issued by education institutions including Massive Open Online Content (MOOCs) providers, universities, Technikons, schools and accreditation agencies is to be considered included. To facilitate storage and retrieval off the blockchain, InterPlanetary File System (IPFS) protocol may be used. Users may access and verify assigned assets through a web-based platform.

### BRIEF DESCRIPTION OF DRAWINGS

The invention will now be further described, by way of example, with reference to the accompanying schematic drawings.

In the Drawings:

FIG. 1 shows a functional block diagram of a certificate issuing system in accordance with one aspect of the invention;

FIG. 2 shows a flow diagram of a computer-implemented method of issuing certificates in accordance with another aspect of the invention;

FIG. 3 shows another flow diagram with method steps for verifying authenticity and/or ownership of certificates; and

FIG. 4 shows a functional block diagram of a computing system.

### DETAILED DESCRIPTION OF AN EXAMPLE EMBODIMENT

The following description of the invention is provided as an enabling teaching of the invention. Those skilled in the relevant art will recognise that many changes can be made to the embodiments described, while still attaining the beneficial results of the present invention. It will also be apparent that some of the desired benefits of the present invention can be attained by selecting some of the features of the present invention without utilising other features. Accordingly, those skilled in the art will recognise that modifications and adaptations to the present invention are possible and can even be desirable in certain circumstances, and are a part of the present invention. Thus, the following description is provided as illustrative of the principles of the present invention and not a limitation thereof.

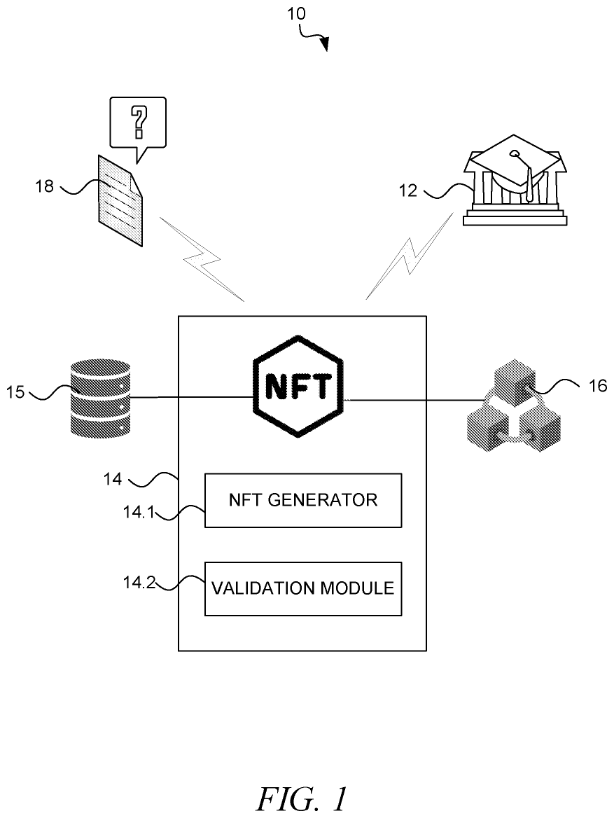

In FIG. 1, reference numeral 10 refers generally to a certificate issuing system in accordance with a first aspect of the invention. The certificate issuing system 10 includes an issuer 12, which in this example embodiment is a university, or any other educational institution, which is communicatively linked to a Non-Fungible Token (NFT) assigner 14 via a communication network. Similarly, a requestor 18 is communicatively linked to the NFT assigner 14 via the communication network. The NFT assigner 14 is linked to a blockchain network 16 in order to store or record assigned NFTs on the blockchain network 16.

The certificate issuing system 10 is configured to issue or assign an NFT to a certificate (asset) using smart contracts. The certificate or asset may be a degree certificate or any form of accreditation issued by the educational institution. The system 10 is used to issue, track and verify the NFTs via an Application Programming Interface (API) provided by the NFT assigner 14. The issuer 12 uses the API to access certificate issuing services provided by the system 10 as a whole. The API allows the issuer 12 to programmatically communicate with the NFT assigner 14 and request NFTs to be issued for specific assets or credentials, i.e. certificates being issued to qualifying students. The API is configured to accept requests from the issuer's system, perform necessary validations and checks and then issue the requested NFTs to the issuer 12. The overview of the certificate issuing system 10 is shown in FIG. 1.

Once the NFTs are issued by the NFT assigner 14, they are registered or stored on the blockchain network 16, providing an immutable and secure record of ownership and authenticity. By leveraging an API to connect with the NFT assigner 14, the issuer 12 can add an additional layer of authentication and verification to their assets and credentials, enabling them to establish trust and transparency with their stakeholders. By leveraging a tamper-evident and decentralized nature of blockchain, NFTs serve as a reliable and immutable record of academic achievements, preventing fraudulent replication or manipulation. Accordingly, the system 10 has the potential to revolutionize the way educational credentials are stored, accessed, and verified, leading to greater trust and transparency in the education sector. Moreover, as more and more certificates are issued through accredited agencies such as Massive Open Online Content (MOOCs) platforms, a central way to prove qualifications in an easy-to-use manner is essential, while offering robustness. The system 10 runs on the Ethereum blockchain 16, reducing the need to setup a stand-alone blockchain which has environmental impacts (excessive energy usage). However, this disclosure encompasses creation of such blockchains in potential future developments.

As mentioned above, for the certificate issuing system 10 to issue NFTs and to verify authenticity, communication is necessary. Accordingly, the system 10 can utilise the Internet, or any wired or wireless network such as a Local Area Network (LAN), Wide Area Network (WAN), Metropolitan Area Network (MAN), or wireless network such as a cellular network. The network may use various technologies like EDGE, GPRS, LTE, ITU IMT-2020, and others. Each network or sub-network may have a wired or wireless data pathway.

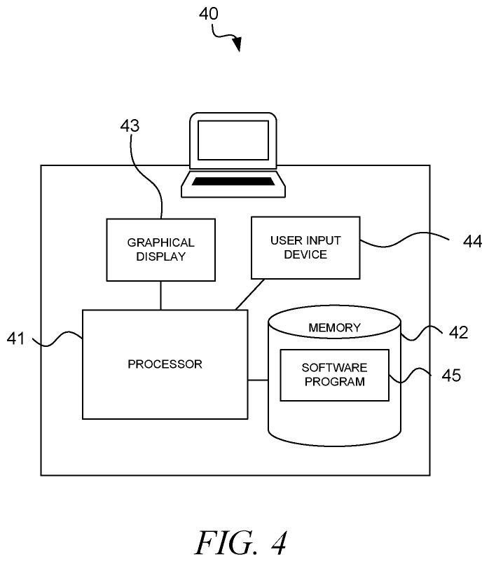

Referring now to FIG. 4, the requestor 18 and/or the NFT assigner 14 may include a distributed or localised computing system 40 which includes a processor 41, memory 42, graphical display 43, user input device 44 and software programs 45 stored in memory 42 to communicate with each other.

The processor 41 is required to communicate with the memory 42. The processor 41 receives and transmits data related to the system 10. The processor 41 can be a Programmable Logic Control unit (PLC), microcontroller, microprocessor, computing device, development board, digital signal processors (DSPs), special-purpose computer chips, field-programmable gate arrays (FPGAs), application-specific integrated circuits (ASICs), computer(s), analogue to digital converters, digital to analogue converters, and/or other support circuits. The processor(s) must have the capability to process the received data and encode messages or information. It includes a clock, an arithmetic logic unit (ALU), and logic gates. The processor(s) must be able to execute one or more software programs 45 that may be stored in the memory 42 or otherwise accessible.

An Application Programming Interface (API) is a set of rules and protocols that allow different software applications to communicate with each other. In technical terms, an API provides a layer of abstraction between the software application and the underlying system, allowing the application to interact with the system through a predefined set of interfaces. By following a set of predefined rules and protocols, the certificate issuing system 10 can offer this complex solution by leveraging the capabilities of other software systems through the API including NFTs and Smart Contracts.

With reference to FIG. 1, to store and retrieve data off the blockchain 16, an InterPlanetary File System (IPFS) 15 is used. This allows the requestor 18, for example, to access and verify the authenticity of a certificate without the need for a centralized file storage system.

The API is used to provide a standardized and structured way for different software systems of issuing organisations for the seamless integration within their platform to have an NFT assigned to their certificates. This will also allow large employee platforms to interlink and demonstrate qualifications on a user's portfolio such as Linkedln.

The NFT assigner 14 creates and issues a tamper-proof and customized NFT on the blockchain 16 by using smart contracts through the API. This allows issuers, in this case, those in the education industry, to issue an NFT associated with a student's certificate.

The IPFS protocol is used to store and retrieve files on the blockchain 16, making it a useful tool for institutions insuring several NFTs at a time. Since IPFS 15 is a distributed system, no single user stores the document. Instead, each node in the system has a part of the file, making it difficult for any one person to access the document at any given time. The uploaded documents are secured and can be accessed with the help of a hash.

The invention supports various types of blockchains, such as public, private, hybrid, and consortium blockchains, among others. The invention can be used with various blockchain networks, including Ethereum, Flow, Tezos, WAX, EOS, TRON, IOST, Ontology, ThunderCore, VeChain, NEO, Steem, Hive, BORA, BSC, Polygon, NEAR, and more. The education industry can use the invention for various purposes, and the invention covers any type of blockchain technology, both existing and emerging.

The system 10 needs to follow the standards for NFTs, such as ERC-721 or ERC-1155, to ensure that the NFTs issued are compatible with other platforms. The system uses appropriate security measures, such as encryption and access control, to prevent unauthorized access and tampering of NFT data. The system uses data efficiently and securely, including the metadata and associated content, to ensure that NFTs are accurately represented and tracked on the blockchain. The API allows users to monitor all NFT transactions and events to ensure the integrity and accuracy of the NFT issuance process. For those who received an NFT (students), a web-based platform will be accessible.

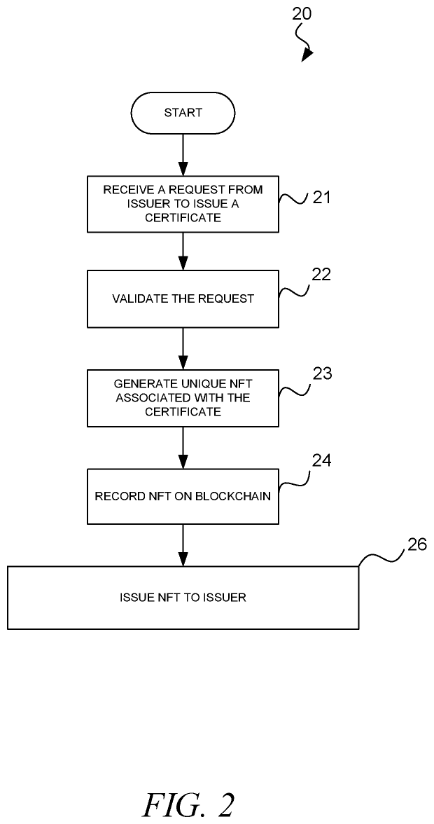

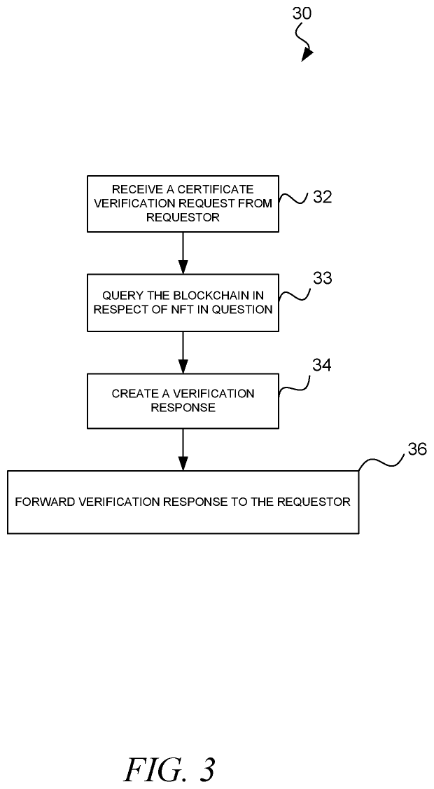

Reference is now made to FIGS. 2 and 3 which illustrate computer-implemented methods 20, 30 of issuing and verifying certificates, respectively. Using their system, the issuer 12 submits a request through the API to the NFT assigner 14 to create/generate an NFT for a specific certificate. The method 20 includes receiving 21, at the NFT assigner 14, the request from the issuer 12 to issue an NFT associated with the certificate. The NFT assigner 14 then validates 22, using a validation module 14.2, the request using cryptographic techniques, ensuring that the request is authentic and authorized. Once the request is validated, the NFT assigner 14 generates 23, using an NFT generator 14.1, a unique and non-interchangeable NFT associated with the certificate. The NFT is then stored or recorded 24 on the blockchain network 16 using the processor 41, providing an immutable and transparent record of ownership and authenticity. The NFT assigner 14 then issues 26 the generated NFT to the issuer 12 through the API, providing a standardized and secure way to retrieve the NFT.

Storage of the NFT on the blockchain network 16, ensures that the NFT is secure, transparent, and tamper-evident. If a potential employer, acting as the requestor 18, would like to verify the authenticity of the potential employee's certificate, the requestor 18 submits a certificate verification request via a web-based platform. The method 30 includes receiving 32, at the NFT assigner 14, the verification request, and querying 33 the blockchain 16 in respect of the NFT in question, and creating 34 a verification response which is forwarded 36, in reply, to the requestor 18. In this manner, the NFT in question can be accessed and verified by authorized parties, establishing trust and transparency in the authenticity of the certificate. Importantly, the recipient of the certificate's details do not have to be stored, rather a link between the issuer and the recipient is stored to verify the assigned NFT associated with the certificate.

The present invention may be a system, a method, and/or a computer program product at any possible technical detail level of integration. The computer program product may include a computer readable storage medium (or media) having computer readable program instructions thereon for causing a processor to carry out aspects of the present invention. The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, Javascript instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, Javascript or the like, and procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and/or computer program products according to embodiments of the invention. It will be understood that each block of the flowchart illustrations and/or block diagrams, and combinations of blocks in the flowchart illustrations and/or block diagrams, can be implemented by computer readable program instructions. These computer readable program instructions may be provided to a processor of a general purpose computer, special purpose computer, or other programmable data processing apparatus to produce a machine, such that the instructions, which execute via the processor of the computer or other programmable data processing apparatus, create modules for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process (or method), such that the instructions which execute on the computer, other programmable apparatus, or other device implement the functions/acts specified in the flowchart and/or block diagram block or blocks. The flowchart and/or block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the blocks may occur out of the order noted in the Figures. For example, two blocks shown in succession may, in fact, be executed substantially concurrently, or the blocks may sometimes be executed in the reverse order, depending upon the functionality involved. It will also be noted that each block of the block diagrams and/or flowchart illustrations, and combinations of blocks in the block diagrams and/or flowchart illustrations, can be implemented by special purpose hardware-based systems that perform the specified functions or acts or carry out combinations of special purpose hardware and computer instructions.

The descriptions of the various embodiments of the present invention have been presented for purposes of illustration but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

The Applicant believes that the use of non-fungible tokens and ownership databases for certificate verification is critical in ensuring trust and authenticity in digital transactions. The certificate issuing system 10 provides a common platform to issue NFT's for certificates, but also allows users, i.e., employers and other institutions to verify such qualifications. As the product suite is developed it will be able to integrate with ERPs to allow Universities, educational institutions, MOOC providers or accreditation agencies to issue verifiable tokens that are linked to a student's certificate. Employers will therefore have the ability to confirm or verify certifications. This can also be relevant for those looking to immigrate to prove qualifications attained etc. Also, recipients (students) of such certificates will have access to one platform to demonstrate their successes across universities and ever-evolving open access platforms. The system aims to integrate with professional platforms such as LinkedIn by extending the API capability.

Consequently, by utilizing blockchain technology, universities and colleges can further enhance their student verification process and overall robustness of accreditation, mitigating the issue of revenue loss through unpermitted verifications. This is a pressing challenge confronting academic institutions currently. Unauthorized or fraudulent certification further aggravates the predicament as it results in fraudulence and fabrication of spurious degrees, posing a significant threat to the university's reputation and brand equity.

To address this the certificate issuing system 10 and methods 20, 30 enable issuing of an NFT associated with a certificate using a smart contract on the blockchain through an API, enabling the secure and efficient creation and management of digital assets. It can also be integrated into external parties' platforms for users who have received an NFT certified qualification to use. In this manner, an organisation can leverage the power of blockchain technology and NFTs to establish trust and transparency in their assets and credentials, preventing fraud and increasing authenticity.

The present invention addresses the existing challenges faced by academic institutions, employers, and individuals in the realm of credential verification by introducing a novel, unified system for issuing, tracking, and verifying NFT tokens associated with various forms of accreditation, such as degrees, certificates, and other forms of educational achievements. This innovative approach provides the following advantages
1. Unified Platform: The invention provides a single, comprehensive platform/system that caters to the diverse needs of universities, educational institutions, MOOC providers, accreditation agencies, employers, and individuals, streamlining the process of issuing and verifying credentials.
2. API Integration: The invention offers an API that allows organizations to seamlessly integrate with the system, enabling them to issue verifiable tokens for their respective credentials within their own ecosystems, as well as ensuring compatibility with ERPs and professional platforms.
3. Enhanced Security and Trust: By leveraging the immutable and secure nature of blockchain technology, specifically the Ethereum blockchain, the invention empowers organizations to establish trust and transparency with their stakeholders, effectively mitigating the risks associated with fraudulent replication, manipulation, and unauthorized verification.
4. Environmental Consideration: The invention initially utilizes the Ethereum blockchain to minimize environmental impacts associated with setting up a stand-alone blockchain, while also encompassing alternative blockchains for future development.
5. Flexibility and Adaptability: The invention is not limited to any specific embodiment, allowing for various modifications and alternative constructions without departing from the spirit and scope of the invention. This adaptability ensures that the platform remains relevant and useful as technology and industry requirements evolve.

In summary, the present invention introduces a new solution that revolutionizes the way educational credentials are managed, accessed, and verified, fostering greater trust and transparency within the education sector, including the ever expanding Massive Open Online Content (MOOC) sector. By providing a unified platform for the issuance, tracking, and verification of NFT tokens associated with various forms of accreditation, the invention offers a secure, efficient, and environmentally-conscious approach to address the pressing challenges of credential management in today's ever-evolving academic and professional landscapes.

1. A computer-implemented method of issuing a certificate, the method comprising:
receiving, via an application programming interface (API), a request to issue a certificate from an issuer;
generating, using a non-fungible token (NFT) generator, an NFT associated with the certificate;
recording, using a processor, the NFT on blockchain; and
issuing, via the API, the NFT to the issuer.

2. The method as claimed in claim 1, further comprising validating, using a validation module, the request using cryptographic techniques prior to generating the NFT.

3. The method as claimed in claim 1, further comprising verifying certificate authenticity and ownership of the NFT without the need for intermediaries by:
receiving, via the API, a certificate verification request from a requestor;
querying, using the processor, the blockchain in respect of the NFT in question;
creating, using the processor, a verification response; and
forwarding, via the API, the verification response to the requestor.

4. The method as claimed in claim 1, wherein the issuer is a Massive Open Online Content (MOOC) provider.

5. A certificate issuing system, comprising,
a non-fungible token (NFT) assigner which includes an NFT generator;
a processor; and
memory having program instructions stored thereon, which when executed by the certificate issuing system enable the system to:
receive, via an application programming interface (API), a request to issue a certificate from an issuer;
generate, using the NFT generator, an NFT associated with the certificate;
record, using the processor, the NFT on blockchain; and
issue, via the API, the NFT to the issuer.

6. The certificate issuing system as claimed in claim 5, which is configured to:
validate, using a validation module, the request using cryptographic techniques prior to generating the NFT.

7. The certificate issuing system as claimed in claim 5, which is configured to verify certificate authenticity and ownership of the NFT without the need for intermediaries by:
receiving, via the API, a certificate verification request from a requestor;
querying, using the processor, the blockchain in respect of the NFT in question; and
creating, using the processor, a verification response; and
forwarding, via the API, the verification response to the requestor.

8. A non-transitory computer-readable storage medium having program instructions stored thereon, which, when executed by a computing system, enable the computing system to perform the method of claim 1.
